(19) United States
(12) Patent Application Publication
(10) Pub. No.: US 2004/0024856 A1
(43) Pub. Date: Feb. 5, 2004

(54) Method and system for a services environment management engine

(76) Inventor: Gary Gere, Emerald Hills, CA (US)

Correspondence Address: WAGNER, MURABITO & HAO LLP, Two North Market Street, Third Floor, San Jose, CA, 95113, US

(21) Appl. No.: 10/209,549

(22) Filed: Jul. 30, 2002

(51) Int. Cl. G06F 15/173

(52) U.S. Cl. 709/223

(57) ABSTRACT

A method and system for implementing a services environment management engine on a computer system. The method includes the step of receiving a request for a service from an application. A services list is dynamically accessed to locate a service provider capable of providing the service. The services list can be generated by accessing a plurality of service providers to determine services respectively provided. The service provider is then contacted and the request for the service is forwarded thereto. A dispatch of the service from the service provider to the application is then verified. The service provider can be contacted using XML messages to forward the request for the service. The service provider can be configured to interact directly with the application to fulfill the request for the service.

### FIELD OF THE INVENTION

The field of the present invention pertains to the provisioning of software based services within a computer system environment. More particularly, the present invention relates to a method and system for configuring and providing software based services having different characteristics and capabilities for a computer system environment.

### BACKGROUND OF THE INVENTION

Computer systems are being used today to perform a wide variety of tasks. Many different areas of business, industry, government, education, entertainment, and most recently, the home, are tapping into the enormous and rapidly growing list of applications developed for today's increasingly powerful computer devices.

Software applications have also become a key technology for communicating ideas, data, and trends in most areas of commerce, science, and education. The operating system of a typical computer system comprises the primary means by which a user interacts with software applications installed on the computer. The typical operating systems are configured to interact with users through graphical user interfaces (GUIs) that support real time user interaction, three dimensional (3D) interactive images, visual representations of real-world system status, and the like.

The operating system and the associated services and capabilities provided there with is often referred to as an operating system environment. Included within the operating system environment is an array of software applications which provide different functions in accordance with the needs and requirements of the user and/or the intended purpose of the computer system. The software applications are often referred to as modules, extensions, or libraries, and function by extending the capability of the operating system environment.

In a typical operating system environment, the primary component is the operating system kernel, which functions as a master control program that generally runs the most basic operations of the computer system. The operating system kernel is typically the first program loaded when the computer is turned on. In general, the kernel resides in memory at all times. The applications “talk to” the operating system kernel for all user interface and file management operations. Also called an “executive” or “supervisor,” a computer operating system insures the multitasking functionality, whereby multiple programs are executed within the computer system at the same time. The number of modules, extensions, etc., that can be effectively multitasked depends on the type of multitasking performed (preemptive vs. cooperative), CPU speed, memory, and disk capacity.

A typical prior art operating system is generally configured for operation with a particular array of software services and applications which comprise the operating system environment. These services and applications typically comprise software programs which provide functions or data which are fundamental to the operation of other software applications which may be installed on the computer system. Such services and applications include, for example, Internet access functions, Ethernet communications functions, file management, memory management functions, and the like.

To ensure reliability and proper operation, all of the various components of the operating system environment are carefully tested, debugged, and released to the end-users as a package. This package as a whole is referred to as the operating system environment. This approach provides advantages with regard to ensuring operation with the particular hardware platform provided by the computer system in which they are installed. The hardware capabilities of the computer system is a significant factor in determining the capability and functionality of the operating system environment.

A problem exists in those situations where it is desirable to implement new functionality with respect to the operating system environment. For example, it is not uncommon to have new hardware released subsequent to the installation of a given operating system environment. Such new hardware often requires new software drivers and new software applications to take advantage of the added functionality. The software drivers and applications need to be properly installed into the operating system environment in order for the new hardware to function. Similarly, the computer system may exist in a network environment where the operating system environment has access to server based applications and services which reside on other computer systems of the network. New services and functions are often added to the network, and when added, often require software modules, extensions, or the like, to be installed in the operating system environment.

The installation of such new drivers and applications can be a significant source of bugs, conflicts, and errors. The new drivers/applications need to be very carefully debugged before they are provided to end-users and installed. Thus, new capabilities and services are not easily added to a given operating system environment while simultaneously ensuring reliable and stable operation. This is unacceptable in certain applications which are critically reliant upon stable, rock solid, computer system operation.

Thus what is required is a solution that can efficiently extend the functionality of a given operating system environment. What is required is a solution that allows new capabilities and functions to be added to an operating system environment as requirements of a given user change. The present invention provides a novel solution to these requirements.

### SUMMARY OF THE INVENTION

Embodiments of the present invention comprise a method and system for a services environment management engine. The services environment management engine embodiments of the present invention extend the functionality of a given operating system environment and provide a solution that allows new capabilities and functions to be added to an operating system environment as requirements of a given user change.

In one embodiment, the present invention is implemented as a computer implemented method for a services environment management engine. The method embodiment includes the step of receiving a request for a service from an application. The application can be, for example, an operating system or some other component of an operating system environment. A services list is dynamically accessed to locate a service provider capable of providing the service. The services list can be generated by accessing a plurality of service providers (e.g., at initial start up of the management engine) to determine services respectively provided. The service provider is then selected and contacted and the request for the service is forwarded thereto. A dispatch of the service from the service provider to the application is then verified (e.g., by removing the request from a queue of pending requests). Communication with the service provider and the requesting application can be implemented using XML messages. The service provider can be local (e.g., installed on the computer system along with the management engine) or remote (e.g., accessed over a network). The service provider can be configured to interact directly with the application to fulfill the request for the service.

Service providers can also message the management engine to request services from other service providers. Similarly, a requesting process can also be a service provider for certain functions. In a case where the requesting process is also a service provider, the management engine can forward requests back to the requesting process for fulfillment. In cases where there are multiple service providers available for a given service, the management engine can select one of the service providers in accordance with, for example, the circumstances of the request (e.g., by using rules, conditions, etc.).

In this manner, functionality of a given operating system environment can be dynamically extended as new services are added and made available to requesting applications. The management engine can query a diverse set of service providers with respect to their capabilities and provide a reliable mechanism for adding such capabilities to an operating system environment.

These and other advantages of the present invention will no doubt become evident to those of ordinary skill in the art after having read the following detailed description of the preferred embodiments which are illustrated in the various drawing figures.

### BRIEF DESCRIPTION OF THE DRAWINGS

The present invention is illustrated by way of example and not by way of limitation, in the figures of the accompanying drawings and in which like reference numerals refer to similar elements and in which:

FIG. 1 shows a generalized overview diagram of an operating system environment in accordance with one embodiment of the present invention.

FIG. 2 shows a diagram of a services environment management engine process in accordance with one embodiment of the present invention.

FIG. 3A shows a diagram showing a service environment management engine functioning to link an appropriate service provider with a requesting process.

FIG. 3B shows two different scenarios where the management engine forwards requests to an appropriate service provider in accordance with one embodiment of the present invention.

FIG. 4 shows a flowchart of the steps of a services environment management engine process in accordance with one embodiment of the present invention.

FIG. 5 shows the components of a computer system platform in accordance with one embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Embodiments of the present invention comprise a method and system for a services environment management engine. The services environment management engine embodiments of the present invention extend the functionality of a given operating system environment and provide a solution that allows new capabilities and functions to be added to an operating system environment as requirements of a given user change.

Notation and Nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

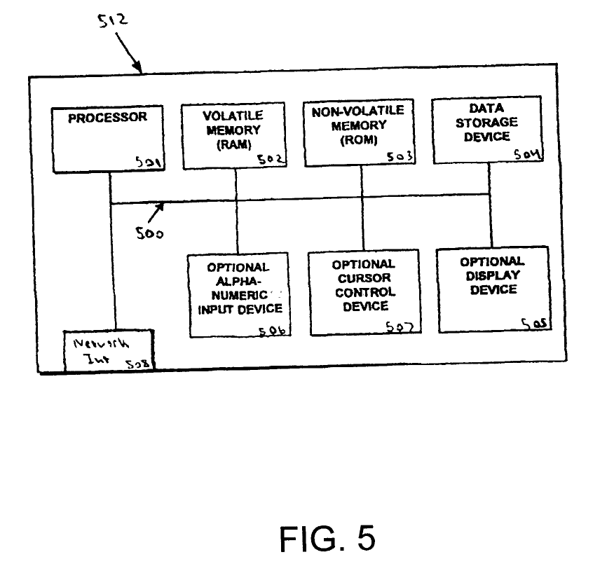

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “generating” or “accessing” or “communicating” or “executing” or “forwarding” or the like, refer to the action and processes of a computer system (e.g., computer system 512 of FIG. 5), or similar electronic computing device, that manipulates and transforms data represented as physical (electronic) quantities within the computer system's registers and memories into other data similarly represented as physical quantities within the computer system memories or registers or other such information storage, transmission or display devices.

Method and System of the Invention

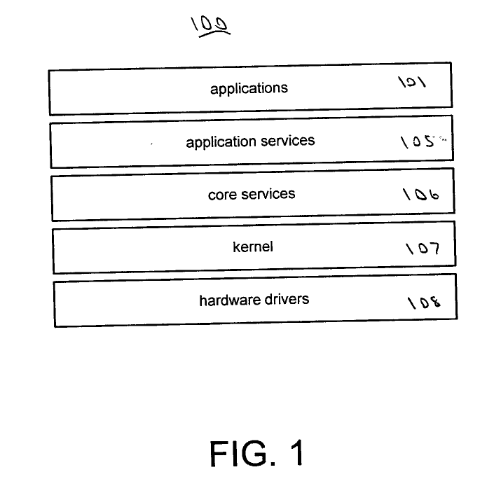

FIG. 1 shows a generalized overview diagram of an operating system environment 100 in accordance with one embodiment of the present invention. As depicted in FIG. 1, the operating. system environment 100 includes an applications layer 101 on top of an application services layer 105. The application services layer 105 resides on top of a core services layer 106. Each of these layers are serviced by a kernel 107. The kernel 107 interfaces with the hardware of the computer system via a hardware drivers layer 108.

Thus, FIG. 1 shows a common manner in which complex software architectures are visually depicted, wherein functionally distinct portions of a software architecture are separated out into “layers.” As diagramed in FIG. 1, one layer sits on top of another, with the most fundamental layer on the bottom. The relationship between the layers of the diagram suggests the general interfaces and dependencies between the layers of software. For example, as depicted in system 100, the higher layers of software, which are the closest to actual application code, depend on the layer immediately under them, and that intermediate layer depends on an even lower layer.

As shown in FIG. 1, the operating system environment 100 is configured for operation with a particular array of software services and applications which comprise the operating system environment. These services and applications, shown as the application services 105 and core services 106, typically comprise software programs which provide functions or data which are fundamental to the operation of other software applications (e.g., applications 101) which may be installed on the computer system. Such services and applications include, for example, Internet access functions, Ethernet communications functions, file management and memory management functions, Java support, and the like. As known by those skilled in the art, all of the various components of the operating system environment are carefully tested, debugged, and released to the end-users as a package in order to ensure proper operation and reliability.

Embodiments of the present invention function by extending this core functionality provided by the operating system environment 100. Embodiments of the present invention enable services and capabilities to be added to the operating system environment 100 in response to the requirements of a user. Accordingly, services and capabilities not provided by the applications 101, application services 105, or even core services 106 can be reliably added.

It should be noted that system 100 as depicted in FIG. 1 is intended to depict a clarified view of the overall architecture of an operating system environment. Those skilled in the art will recognize simplifications inherent in the FIG. 1 depiction. The services and subsystems that one application uses, and how it uses them, can be very different from those used by another application, even one of a similar type. Dependencies and interfaces at the different levels can vary from program to program depending on individual requirements and realities. In one embodiment of the present invention, the operating system environment of computer system 100 is a Solaris™ operating system environment.

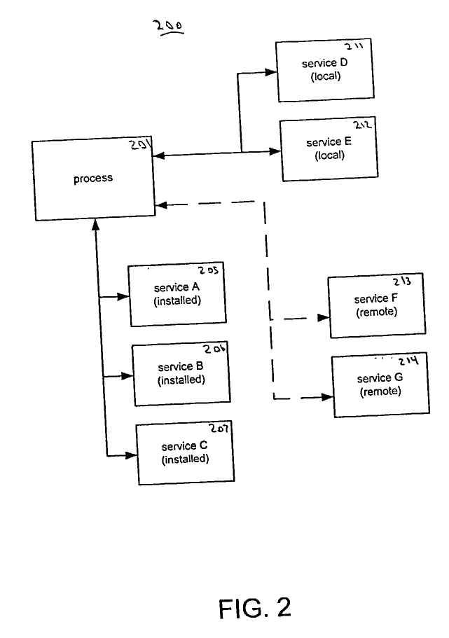

FIG. 2 shows a diagram of a services environment management engine process 200 in accordance with one embodiment of the present invention. As depicted in FIG. 2, a process 201 is coupled to receive and interact with installed services 205-207, local services 211-212, and remote network connected services 213-214.

The process 201 is a software based process executing on a computer system in accordance with one embodiment of the present invention (e.g., computer system 512 of FIG. 5). As used herein, the process 201 can refer to a software application that provides functionality similar to application services 105, core services 106, or even functionality similar to another application 101.

The services environment management engine of the present invention extends the capabilities of the process 201 by providing access to additional services provided by service providers. As depicted in FIG. 2, three types of service providers are shown. Service providers 205-207 are installed service providers. Service providers 211-212 are local service providers. Service providers 213-214 are remote service providers. As used herein, installed service providers refer to those service providers which are installed as part of the operating system environment 100. An example would be a Java virtual machine installed as part of the application services 105. Local service providers refers to those service providers which reside on the same computer system platform as the process 201. Examples include other applications which are multitasking with the process 201, but which are not installed as part of application services 105 or core services 106. Remote service providers refers to those services which are accessed on other computer systems, for example, via a network (Internet, intranet, etc.). The network based connectivity to the remote services 213-214 is shown as the dotted line connecting them to the process 201.

In accordance with embodiments of the present invention, the service providers 205-214 can be dynamically coupled to the process 201 in accordance with real-time requests for service by the process 201. For example, a situation where the process 201 requires a service for which it has no installed functionality, embodiments of the present invention can locate and ensure the appropriate service provider provides the need functionality to the process 201. The required functionality can be located and coupled to the process 201 regardless of whether the service provider is an installed service provider, a local service provider, or a remote service provider.

It should be noted that the term “service provider” is used broadly to refer to any of a number of different programs that can provide services or data to a requesting process. For example, a service provider can refer to a hardware device driver (e.g., printer server) installed locally on the computer system platform. A service provider can also refer to a remote service accessed via the Internet (e.g., FTP server). Additionally, a service provider can also be a “plug-in” designed to install into the application service layer 105 or core services layer 106 (e.g., a Java virtual machine, a BASIC interpreter, multimedia streamer, etc.). Similarly, it should be noted that the term “process” is used broadly to refer to any of a number of different programs that may execute on a computer system platform, typically, but not necessarily, as part of the applications layer 101.

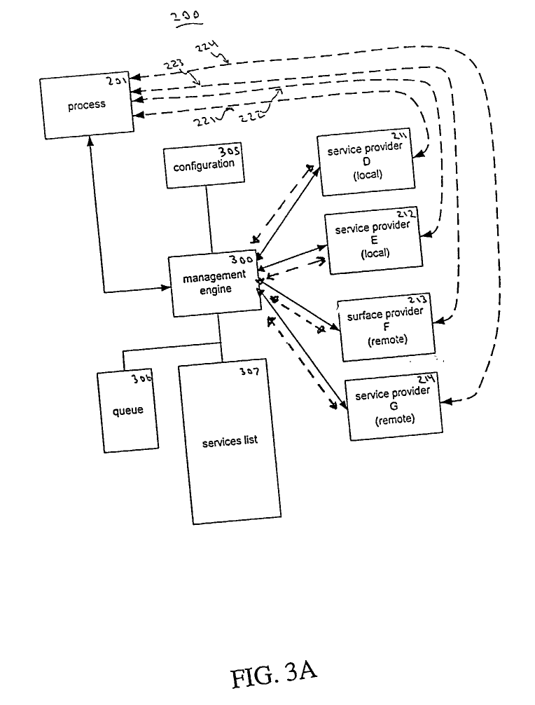

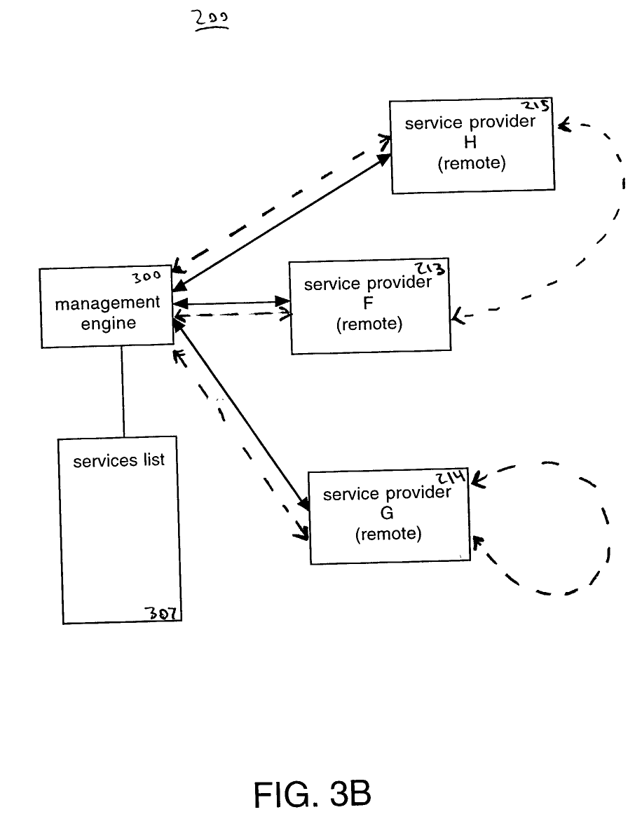

FIG. 3A shows a diagram showing a service environment management engine functioning to link an appropriate service provider with a requesting process. In the present embodiment, the service environment management engine, or simply management engine 300, is implemented as a software program executing on a computer system (e.g., computer system 512 of FIG. 5).

As shown in FIG. 3A, the management engine 300 receives requests for a service from an application, in this case, process 201. The process 201 can be, for example, an operating system or some other component of an operating system environment, as described above in the description of FIG. 1. To fulfill the request for service, a services list 307 is dynamically accessed to locate a service provider capable of providing the service.

In the present embodiment, the services list 307 is generated by accessing all those service providers (e.g., at initial start up of the management engine) which are known to management engine 300 to determine services they respectively provide. The queried service providers can be local, remote, or installed, as described above. This information is compiled into the services list 307, and is updated as necessary, or in accordance with a management engine configuration file 305. In this manner, the management engine 300 maintains a registry of the services available.

Once a service provider that can provide the requested service is located in the services list 307, that service provider is then selected and contacted, and the request for the service is forwarded thereto. In a case where a number of requests are outstanding at a given time, pending requests are stored in a queue 306. In the present embodiment, the requests stored in the queue are serviced on a first-in first-out basis. Once the request is forwarded to the selected service provider, the service from the service provider to the process 201 is then verified (e.g., by removing the request from the queue 306).

Referring still FIG. 3A, in the present embodiment, the service provider is configured to interact directly with the process 201 to fulfill the request for the service, once the request for service is received from the management engine 300. This is shown by the dotted lines 221-224 which show communication directly between the service providers 211-214. Accordingly, the requests forwarded to the service providers can include address information regarding the requesting process 201.

Embodiments of the present invention can be configured to use XML (extensible markup language) based communication standards. For example, communication with a given service provider and the requesting process 201 can be implemented using XML messages.

FIG. 3B shows two different scenarios where the management engine 300 forwards requests to an appropriate service provider in accordance with one embodiment of the present invention. In the present embodiment, service providers can be configured to message the management engine to request a required service from other service providers. This is shown in FIG. 3B, where the service provider 213 sends a request to the management engine 300, the management engine 300 selects a service provider from the services list 307, forwards the request to the selected service provider 215, which then communicates directly with the calling service provider 213.

Similarly, in the present embodiment, a requesting process can also be a service provider for certain functions. In a case where the requesting process is also a service provider, the management engine can forward a request back to the requesting process for fulfillment. This is shown in FIG. 3B where the service provider 214 sends a request to the management engine 300, the management engine selects the service provider 214 from the services list 307, and the request is sent directly back to the requesting process, in this case, service provider 214, to fulfill its own request (e.g., the dotted line looping around from service provider 214 back to provider 214).

In cases where there are multiple service providers available for a given service, the management engine 300 can select one of the service providers in accordance with, for example, the circumstances of the request (e.g., by using rules, conditions, etc.). Thus, for example, where there are multiple service providers capable of performing a given service (e.g., service provider 215 and 214) for a requesting service provider 213, the management engine 300 can select the appropriate service provider by considering, for example, whether one service provider is more busy with respect to another, whether one offers better performance with respect to another, has better connectivity, or the like.

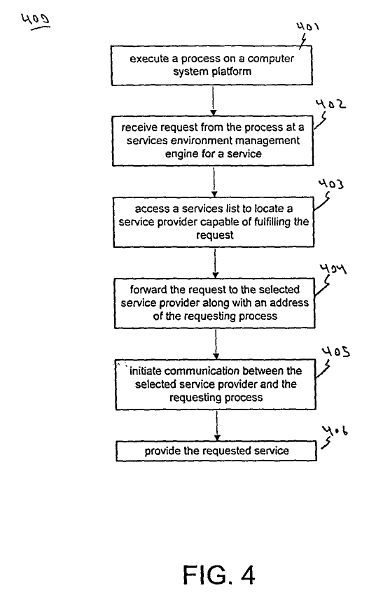

FIG. 4 shows a flowchart of the steps of a process 400 in accordance with one embodiment of the present invention. As depicted in FIG. 4, process 400 shows the steps of a services environment management process adding functionality to an operating system environment of a computer system.

Process 400 begins in step 401, where a process (e.g., process 201) on a computer system platform is executed. In step 402, a request is received from the process 201 at a services environment management engine (e.g., management engine 300). In step 403, the management engine accesses a services list (e.g., services list 307) to locate a service provider capable of fulfilling the request. Subsequently, in step 404, the request is forwarded to the selected service provider along with an address of the requesting process. As described above, in a case where several requests are outstanding, the request can be stored in a queue for subsequent fulfillment. As described above, the selected service providers could also message the management engine to request services from another service provider in order to fulfill the original request. Similarly, the requesting process can also be a service provider, or there may be multiple service providers available for the requested service. In each case, the management engine ensures the select service provider is in appropriate for the circumstances of the request.

Referring still to process 400 of FIG. 4, in step 405, communication is initiated between the selected service provider and the requesting process. As described above, in one embodiment, this communication is direct, wherein the selected service provider is not required to continue using the management engine as an intermediary for the requesting process. In step 406, the requested service is provided by the service provider to the requesting process.

### Computer System Platform

With reference now to FIG. 5, a computer system 512 in accordance with one embodiment of the present invention is shown. Computer system 512 shows the components of a computer system in accordance with one embodiment of the present invention that provides the execution platform for implementing certain software-based functionality of the present invention. As described above, certain processes and steps of the present invention are realized, in one embodiment, as a series of instructions (e.g., software program) that reside within computer readable memory units of a computer system (e.g., system 512) and are executed by the processor(s) of system 512. When executed, the instructions cause the computer system 512 to implement the functionality of the present invention as described above.

In general, computer system 512 comprises an address/data bus 500 for communicating information, one or more central processors 501 coupled with the bus 500 for processing information and instructions, a computer readable volatile memory unit 502 (e.g., random access memory, static RAM, dynamic, RAM, etc.) coupled with the bus 500 for, storing information and instructions for the central processor(s) 501, a computer readable non-volatile memory unit 503 (e.g., read only memory, programmable ROM, flash memory, EPROM, EEPROM, etc.) coupled with the bus 500 for storing static information and instructions for the processor(s) 501. System 512 also includes a mass storage computer readable data storage device 504 such as a magnetic or optical disk and disk drive coupled with the bus 500 for storing information and instructions. Optionally, system 512 can include a display device 505 coupled to the bus 500 for displaying information to the computer user, an alphanumeric input device 506 including alphanumeric and function keys coupled to the bus 500 for communicating information and command selections to the central processor(s) 501, a cursor control device 507 coupled to the bus for communicating user input information and command selections to the central processor(s) 501, and a network interface device 508 coupled to the bus 500 for communicating with other computer systems on a coupled network.

Thus, embodiments of the present invention comprise a method and system for a services environment management engine. The services environment management engine embodiments of the present invention extend the functionality of a given operating system environment and provide a solution that allows new capabilities and functions to be added to an operating system environment as requirements of a given user change.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for implementing a services environment management engine on a computer system comprising:
receiving a request for a service from an application;
dynamically accessing a services list to locate a service provider capable of providing the service;
contacting the service provider to forward the request for the service; and
verifying a dispatch of the service from the service provider to the application.

2. The method of claim 1 further comprising:
generating the services list by accessing a plurality of service providers to determine services respectively provided.

3. The method of claim 1 further comprising:
receiving a plurality of requests for services;
storing the requests in a queue;
forwarding the requests from the queue to an available server provider on a first-in first-out basis; and
verifying of the dispatch of the service from the service provider to the application by removing a corresponding request stored in the queue.

4. The method of claim 1 further comprising:
contacting the service provider to forward the request for the service by using an XML message.

5. The method of claim 1 wherein contacting the service provider to forward the request for service includes providing an address of the application to the service provider.

6. The method of claim 1 wherein the service provider is configured to interact directly with the application to fulfill the request for the service.

7. A system for implementing a services environment management engine comprising:
a computer system having a processor coupled to a memory, the memory having computer readable code which when executed by the processor causes the computer system to implement a method comprising:
receiving a request for a service from a process;
dynamically accessing a services list to locate a service provider capable of providing the service;
contacting the service provider to forward the request for the service; and
verifying a dispatch of the service from the service provider to the process.

8. The system of claim 7 further comprising:
generating the services list by accessing a plurality of service providers to determine services respectively provided.

9. The system of claim 7 further comprising:
receiving a plurality of requests for services;
storing the requests in a queue; and
forwarding the requests from the queue to an available server provider on a first-in first-out basis.

10. The system of claim 9 wherein the verifying of the dispatch of the service from the service provider to the process comprises removing a corresponding request stored in the queue.

11. The system of claim 7 further comprising:
contacting the service provider to forward the request for the service by using an XML message.

12. The system of claim 7 wherein contacting the service provider to forward the request for service includes providing an address of the process to the service provider.

13. The system of claim 7 wherein the service provider is configured to interact directly with the process to fulfill the request for the service.

14. A computer readable media having computer readable code which when executed by a computer system cause the computer system to implement a services environment management engine method comprising:
receiving a request for a service from an application;
generating a services list by accessing a plurality of service providers to determine services respectively provided;
accessing the services list to select a service provider capable of providing the service;
contacting the selected service provider to forward the request for the service; and
verifying a dispatch of the service from the selected service provider to the application.

15. The computer readable media of claim 14 further comprising:
receiving a plurality of requests for services;
storing the requests in a queue; and
forwarding the requests from the queue to an available server provider on a first-in first-out basis.

16. The computer readable media of claim 14 further comprising:
contacting the selected service provider to forward the request for the service by using an XML message.

17. The computer readable media of claim 14 wherein contacting the selected service provider to forward the request for service includes providing an address of the application to the selected service provider.

18. The computer readable media of claim 14 wherein the selected service provider is configured to interact directly with the application to fulfill the request for the service.

19. A system for implementing a services environment management engine on a computer system comprising:
means for receiving a request for a service from an application;
means for generating a services list by accessing a plurality of service providers to determine services respectively provided;
means for accessing the services list to select a service provider capable of providing the service;
means for contacting the selected service provider to forward the request for the service; and
means for verifying a dispatch of the service from the selected service provider to the application.

20. The system of claim 19 wherein the selected service provider is configured to interact directly with the application to fulfill the request for the service.
